(19) United States
(12) Patent Application Publication
(10) Pub. No.: US 2025/0075126 A1
(43) Pub. Date: Mar. 6, 2025

(54) DIQUATERNARY COMPOUNDS FOR CORROSION INHIBITION AND METHODS OF USE THEREOF

(71) Applicant: ChampionX LLC, Sugar Land, TX (US)

(72) Inventors: Jing Wu, Missouri City, TX (US); Shelley Zhou, Sugar Land, TX (US); Jeremy Moloney, Katy, TX (US)

(21) Appl. No.: 18/804,695

(22) Filed: Aug. 14, 2024

Related U.S. Application Data
(60) Provisional application No. 63/534,907, filed on Aug. 28, 2023.

(51) Int. Cl. C09K 15/22; C02F 5/12; C02F 103/10; C09K 8/54; C09K 15/12; C23F 11/14

(52) U.S. Cl. CPC C09K 15/22; C02F 5/12; C09K 8/54; C09K 15/12; C23F 11/145; C02F 2103/10; C02F 2303/08; C09K 2208/32

(57) ABSTRACT

Compositions for corrosion inhibition and methods of using the same are disclosed to replace conventional corrosion inhibitors with improved performance and improved environmental profiles.

### CROSS REFERENCE TO RELATED APPLICATIONS

This application claims priority under 35 U.S.C. § 119 to provisional patent application U.S. Ser. No. 63/534,907, filed Aug. 28, 2023. The provisional patent application is herein incorporated by reference in its entirety, including without limitation, the specification, claims, and abstract, as well as any figures, tables, appendices, or drawings thereof.

### TECHNICAL FIELD

The present disclosure relates generally to corrosion-inhibiting compositions and methods for improved corrosion inhibition of metal surfaces in oil and gas application using alkyl diquaternary compounds and corrosion-inhibiting compositions comprising the same to replace conventional corrosion inhibitors with improved performance and improved environmental profiles.

### BACKGROUND

Corrosion remains a significant challenge in the oil and gas industry and are most often caused by salts and/or other dissolved solids, liquids, or gases that cause, accelerate, or promote corrosion of surfaces such as metal surfaces. Controlling internal corrosion is a key problem encountered in flowlines and pipelines made from metal, namely carbon steel.

Examples of corrodents include carbon dioxide, oxygen, sodium chloride, calcium chloride, and sulfur dioxide. Corrosion negatively impacts metal containments such as metal pipelines, tanks, and/or other metal equipment or devices that contact aqueous liquid sources before, during, or after injection or production.

Most operators in the oil and gas extraction and processing industry employ corrosion inhibitors to reduce internal corrosion in metal containments which are contacted by aqueous liquids containing corrodents. Corrodents are found in injectates, produced water, connate (native water present in subterranean formations along with the hydrocarbon), and hydrocarbon liquids and solids. Corrosion inhibitors are added to the liquids and dissolved gases which come into contact with metal surfaces where they act to prevent, retard, delay, reverse, and/or otherwise inhibit the corrosion of metal surfaces such as carbon-steel metal surfaces. Corrosion inhibitors can include, for example, aliphatic and aromatic amines, amine salts of acids, heterocyclic amines, alkenyl succinic acid, triazoles, and the like.

Corrosion inhibitors are beneficial in that they extend the lifespan of metal surfaces, as well as permit the use of carbon steel components rather than more expensive metals, such as nickel, cobalt, and chromium alloys or other materials more expensive than carbon steel and/or which inherently entail other disadvantages in suitability for the purpose of liquid or gas containment.

It is an object of this disclosure to provide alkyl diquaternary compound and corrosion-inhibiting compositions including the same, and methods for corrosion inhibition of metal surfaces that improve beyond the corrosion inhibition capability of existing corrosion inhibitors.

It is a particular object of the disclosure to provide the alkyl diquaternary compounds and compositions including the same to provide improve performance of corrosion inhibitors in hard conditions, including high shear stress, high temperature and high water cuts. It is a further object of the disclosure to provide the alkyl diquaternary compound and corrosion-inhibiting compositions including the same to provide an environmentally friendly corrosion inhibition composition and methods of corrosion inhibition.

Other objects, embodiments advantages of this disclosure will be apparent to one skilled in the art in view of the following disclosure, the drawings, and the appended claims.

### SUMMARY

The following objects, features, advantages, aspects, and/or embodiments, are not exhaustive and do not limit the overall disclosure. No single embodiment need provide each and every object, feature, or advantage. Any of the objects, features, advantages, aspects, and/or embodiments disclosed herein can be integrated with one another, either in full or in part.

It is an object, feature, and/or advantage of the present disclosure to provide compositions and methods for inhibiting corrosion in oil-field systems, namely pipelines, containing oxygen, hydrogen systems and/or hydrogen mediums.

According to some aspects of the present disclosure, corrosion-inhibiting compositions comprise alkyl diquaternary compounds as described herein and a solvent, and optionally additional functional ingredients. In an aspect, the alkyl diquaternary compounds have the

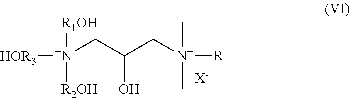

or

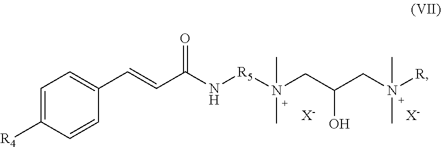

wherein:
R is a linear C₈-C₃₀ alkyl group,
R₁, R₂, and R₃ are independently a linear C₁-C₃ alkyl group,
R₄ is H, —OCH₃, or C₁-C₈ alkyl group,
R₅ is a linear C₁-C₃ alkyl group, and
X— is a halide, and
a solvent.

According to a further aspect of the present disclosure, methods of controlling corrosion on a surface comprise: providing a corrosive inhibiting effective amount of a corrosion inhibition composition as described herein into contact with a surface comprising metal and is in an oil-field system, a hydrogen system and/or a hydrogen medium and wherein the contacting is added in a batch or continuous application, and reducing corrosion on the surface.

According to a further aspect of the present disclosure, treated metal containments comprise a metal containment comprising a metal surface; and a barrier or film substantially coating the metal surface with a corrosive inhibiting effective amount of the compositions described herein.

These and/or other objects, features, advantages, aspects, and/or embodiments will become apparent to those skilled in the art after reviewing the following brief and detailed descriptions of the drawings. Furthermore, the present disclosure encompasses aspects and/or embodiments not expressly disclosed but which can be understood from a reading of the present disclosure, including at least: (a) combinations of disclosed aspects and/or embodiments and/or (b) reasonable modifications not shown or described.

While multiple embodiments are disclosed, still other embodiments will become apparent to those skilled in the art from the following detailed description, which shows and describes illustrative embodiments. Accordingly, the drawings and detailed description are to be regarded as illustrative in nature and not restrictive.

### BRIEF DESCRIPTION OF THE DRAWINGS

FIG. 1 shows a reaction to produce the alkyl diquaternary compounds of structure (VI) as described herein.

FIG. 2 shows a further reaction to produce the alkyl diquaternary compounds of structure (VI) as described herein.

FIG. 3A shows a reaction to produce an intermediate (III) in the reaction to make the alkyl diquaternary compounds of structure (VII) as described herein.

FIG. 3B shows a reaction to produce the alkyl diquaternary compounds of structure (VII) as described herein.

FIG. 4A shows a reaction to produce an intermediate (III) in the reaction to make the alkyl diquaternary compounds of structure (VII) as described herein.

FIG. 4B shows a reaction to produce the alkyl diquaternary compounds of structure (VII) as described herein.

Various embodiments of the present disclosure will be described in detail with reference to the drawings, wherein like reference numerals represent like parts throughout the several views. Reference to various embodiments does not limit the scope of the disclosure. Figures represented herein are not limitations to the various embodiments according to the disclosure and are presented for exemplary illustration of the invention. An artisan of ordinary skill in the art need not view, within isolated figure(s), the near infinite number of distinct permutations of features described in the following detailed description to facilitate an understanding of the present invention.

### DETAILED DESCRIPTION

The present disclosure is not to be limited to that described herein, which can vary and are understood by skilled artisans. No features shown or described are essential to permit basic operation of the present disclosure unless otherwise indicated. It has been beneficially found that alkyl diquaternary compounds as described herein provide effective corrosion-inhibiting compositions.

It is further to be understood that all terminology used herein is for the purpose of describing particular embodiments only, and is not intended to be limiting in any manner or scope. For example, as used in this specification and the appended claims, the singular forms “a,” “an” and “the” can include plural referents unless the content clearly indicates otherwise. Further, all units, prefixes, and symbols may be denoted in its SI accepted form.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4%. This applies regardless of the breadth of the range.

As used herein, the term “and/or”, e.g., “X and/or Y” shall be understood to mean either “X and Y” or “X or Y” and shall be taken to provide explicit support for both meanings or for either meaning, e.g. A and/or B includes the options i) A, ii) B or iii) A and B.

It is to be appreciated that certain features that are, for clarity, described herein in the context of separate embodiments, may also be provided in combination in a single embodiment. Conversely, various features that are, for brevity, described in the context of a single embodiment, may also be provided separately or in any sub-combination.

The methods and compositions of the present disclosure may comprise, consist essentially of, or consist of the components and ingredients of the present disclosure as well as other ingredients described herein. As used herein, “consisting essentially of” means that the methods, systems, apparatuses and compositions may include additional steps, components or ingredients, but only if the additional steps, components or ingredients do not materially alter the basic and novel characteristics of the claimed methods, systems, apparatuses, and compositions.

Unless defined otherwise, all technical and scientific terms used above have the same meaning as commonly understood by one of ordinary skill in the art to which embodiments of the present disclosure pertain.

The terms “invention” or “present invention” are not intended to refer to any single embodiment of the particular invention but encompass all possible embodiments as described in the specification and the claims.

The term “about,” as used herein, refers to variation in the numerical quantity that can occur, for example, through typical measuring techniques and equipment, with respect to any quantifiable variable, including, but not limited to, concentration, mass, volume, time, molecular weight, temperature, pH, molar ratios, and the like. Further, given solid and liquid handling procedures used in the real world, there is certain inadvertent error and variation that is likely through differences in the manufacture, source, or purity of the ingredients used to make the compositions or carry out the methods and the like. The term “about” also encompasses these variations. Whether or not modified by the term “about,” the claims include equivalents to the quantities.

The term “actives” or “percent actives” or “percent by weight actives” or “actives concentration” are used interchangeably herein and refers to the concentration of those ingredients involved in cleaning expressed as a percentage minus inert ingredients such as water or salts. It is also sometimes indicated by a percentage in parentheses, for example, “chemical (10%).”

As used herein, the term “alkyl” or “alkyl groups” refers to saturated hydrocarbons having one or more carbon atoms, including straight-chain alkyl groups (e.g., methyl, ethyl, propyl, butyl, pentyl, hexyl, heptyl, octyl, nonyl, decyl, etc.), cyclic alkyl groups (or “cycloalkyl” or “alicyclic” or “carbocyclic” groups) (e.g., cyclopropyl, cyclopentyl, cyclohexyl, cycloheptyl, cyclooctyl, etc.), branched-chain alkyl groups (e.g., isopropyl, tert-butyl, sec-butyl, isobutyl, etc.), and alkyl-substituted alkyl groups (e.g., alkyl-substituted cycloalkyl groups and cycloalkyl-substituted alkyl groups). Unless otherwise specified, the term “alkyl” includes both “unsubstituted alkyls” and “substituted alkyls.” As used herein, the term “substituted alkyls” refers to alkyl groups having substituents replacing one or more hydrogens on one or more carbons of the hydrocarbon backbone. Such substituents may include, for example, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino, and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl, or aromatic (including heteroaromatic) groups.

In some embodiments, substituted alkyls can include a heterocyclic group. As used herein, the term “heterocyclic group” includes closed ring structures analogous to carbocyclic groups in which one or more of the carbon atoms in the ring is an element other than carbon, for example, nitrogen, sulfur or oxygen. Heterocyclic groups may be saturated or unsaturated. Exemplary heterocyclic groups include, but are not limited to, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran, and furan.

The terms “aryl” or “ar” as used herein alone or as part of another group (e.g., aralkyl) denote optionally substituted homocyclic aromatic groups, preferably monocyclic or bicyclic groups containing from 6 to 12 carbons in the ring portion, such as phenyl, biphenyl, naphthyl, substituted phenyl, substituted biphenyl or substituted naphthyl. Phenyl and substituted phenyl are commonly used aryls. The term “aryl” also includes heteroaryl.

“Arylalkyl” means an aryl group attached to the parent molecule through an alkylene group. In some embodiments the number of carbon atoms in the aryl group and the alkylene group is selected such that there is a total of about 6 to about 18 carbon atoms in the arylalkyl group. A commonly used arylalkyl group is benzyl.

As used herein, the term “between” is inclusive of any endpoints noted relative to a described range.

As used herein, the term “containment” or “metal containment” includes any metal surface or portion thereof that is in contact with liquids in an oil-field system, hydrogen system and/or hydrogen medium containing corrodent(s). In embodiments the containment is in fluid communication with one or more devices or apparatuses, including other containments. In embodiments the containment is a pipe. In embodiments the containment is a tank. In embodiments, the metal is steel. In embodiments, the steel is carbon steel. In embodiments, the carbon steel is stainless steel.

As used herein, the term “corrodent” refers to one or more salts and/or other dissolved solids, liquids, or gasses that cause, accelerate, or promote corrosion. Non-limiting examples of corrodents are oxygen, hydrogen sulfide, hydrogen chloride, carbon dioxide, sodium chloride, calcium chloride, sulfur dioxide, and combinations thereof. In exemplary embodiments, corrodents are capable of corroding a carbon steel at a rate of at least about 100 milli-inches per year (mpy).

The term “-ene” as used as a suffix as part of another group denotes a bivalent substituent in which a hydrogen atom is removed from each of two terminal carbons of the group, or if the group is cyclic, from each of two different carbon atoms in the ring. For example, alkylene denotes a bivalent alkyl group such as methylene (—CH₂—) or ethylene (—CH₂CH₂—), and arylene denotes a bivalent aryl group such as o-phenylene, m-phenylene, or p-phenylene.

As used herein, the term “exemplary” refers to an example, an instance, or an illustration, and does not indicate a most preferred embodiment unless otherwise stated.

The phrase “free of” or similar phrases if used herein means that the composition comprises 0% of the stated component and refers to a composition where the component has not been intentionally added. However, it will be appreciated that such components may incidentally form thereafter, under some circumstances, or such component may be incidentally present, e.g., as an incidental contaminant.

The term “generally” encompasses both “about” and “substantially.”

The term “inhibiting” as referred to herein includes both inhibiting and preventing corrosion on a surface or within a system, namely an oil-field system, hydrogen system and/or hydrogen medium.

As used herein, the term “optional” or “optionally” means that the subsequently described component, event or circumstance may but need not be present or occur. The description therefore discloses and includes instances in which the event or circumstance occurs and instances in which it does not, or instances in which the described component is present and instances in which it is not.

As used herein the term “polymer” refers to a molecular complex comprised of a more than ten monomeric units and generally includes, but is not limited to, homopolymers, copolymers, such as for example, block, graft, random and alternating copolymers, terpolymers, and higher “x”mers, further including their analogs, derivatives, combinations, and blends thereof. Furthermore, unless otherwise specifically limited, the term “polymer” shall include all possible isomeric configurations of the molecule, including, but are not limited to isotactic, syndiotactic and random symmetries, and combinations thereof. Furthermore, unless otherwise specifically limited, the term “polymer” shall include all possible geometrical configurations of the molecule.

As used herein, the term “produced water” means a water source that flows from a subterranean formation in a hydrocarbon recovery process such as hydraulic fracturing or tertiary oil recovery, further wherein the water source includes one or more hydrocarbons, one or more dissolved solids, or a combination thereof.

The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

The term “substantially” refers to a great or significant extent. “Substantially” can thus refer to a plurality, majority, and/or a supermajority of said quantifiable variable, given proper context.

The term “substituted” as in “substituted aryl,” “substituted alkyl,” and the like, means that in the group in question (i.e., the alkyl, aryl or other group that follows the term), at least one hydrogen atom bound to a carbon atom is replaced with one or more substituent groups such as hydroxy (—OH), alkylthio, phosphino, amido (—CON(R_{A})(R_{B}), wherein R_{A} and R_{B} are independently hydrogen, alkyl, or aryl), amino(—N(R_{A})(R_{B}), wherein R_{A} and R_{B} are independently hydrogen, alkyl, or aryl), halo (fluoro, chloro, bromo, or iodo), silyl, nitro (—NO₂), an ether (—OR_{A} wherein R_{A} is alkyl or aryl), an ester (—OC(O)R_{A} wherein R_{A} is alkyl or aryl), keto (—C(O)R_{A} wherein R_{A} is alkyl or aryl), heterocyclo, and the like. Further, an alkylene group in the chain can be replaced with an ether, an amine, an amide, a carbonyl, an ester, a cycloalkyl, or a heterocyclo functional group. When the term “substituted” introduces a list of possible substituted groups, it is intended that the term apply to every member of that group. That is, the phrase “optionally substituted alkyl or aryl” is to be interpreted as “optionally substituted alkyl or optionally substituted aryl.”

As used herein, the term “substantially free” refers to compositions completely lacking the component or having such a small amount of the component that the component does not affect the performance of the composition. The component may be present as an impurity or as a contaminant and shall be less than 0.5 wt-%. In another embodiment, the amount of the component is less than 0.1 wt-% and in yet another embodiment, the amount of component is less than 0.01 wt-%.

The term “weight percent,” “wt-%,” “percent by weight,” “% by weight,” and variations thereof, as used herein, refer to the concentration of a substance as the weight of that substance divided by the total weight of the composition and multiplied by 100. It is understood that, as used here, “percent,” “%,” and the like are intended to be synonymous with “weight percent,” “wt-%,” etc.

### Corrosion-Inhibiting Compositions

According to embodiments, the corrosion-inhibiting compositions include an alkyl diquaternary compound according to structure VI or VII as described herein and a solvent. Additional functional ingredients can be included in the compositions as described herein. In embodiments the compositions are solutions or dispersions. The alkyl diquaternary compound can be in a solution or dispersion in the solvent to make up the corrosion-inhibiting compositions. The alkyl diquaternary compounds described herein provide chain lengths for water solubility and hydrophobicity while the two nitrogen heteroatoms provided efficient binding to surfaces in need of corrosion inhibition. Beneficially the dual nitrogen heteroatoms provide enhanced binding to surfaces to anchor the corrosion-inhibitors to the surfaces including under high shear conditions.

### Alkyl Diquaternary Compounds

The alkyl diquaternary compounds included in the corrosion-inhibiting compositions have one of the following structures:

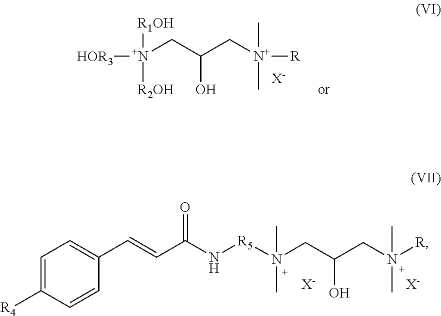

wherein:
R is a linear C₈-C₃₀ alkyl group,
R₁, R₂, and R₃ are independently a linear C₁-C₃ alkyl group,
R₄ is H, —OCH₃, or C₁-C₈ alkyl group,
R₅ is a linear C₁-C₃ alkyl group, and
X— is a halide.

In embodiments, the alkyl diquaternary compounds have the following structure (VI):

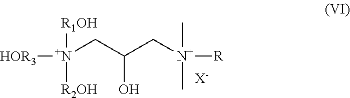

wherein:
R is a linear C₈-C₃₀ alkyl group,
R₁, R₂, and R₃ are independently a linear C₁-C₃ alkyl group,
R₄ is H, —OCH₃, or C₁-C₄ alkyl group,
R₅ is a linear C₁-C₃ alkyl group, and
X— is a halide.

In further embodiments the alkyl diquaternary compounds have the structure (VI):

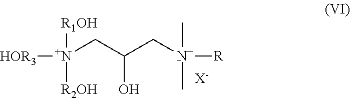

wherein:
R is a linear C₁₀-C₂₄ alkyl group,
R₁, R₂, and R₃ are the same linear C₁-C₃ alkyl group,
R₄ is H, or C₁-C₄ alkyl group,
R₅ is a linear C₁-C₃ alkyl group, and
X— is a halide, preferably chloro or bromo (Cl⁻ or Br⁻).

In further embodiments the alkyl diquaternary compounds have the structure (VI):

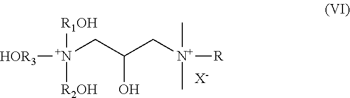

wherein:
R is a linear C₁₂-C₂₄ alkyl group,
R₁, R₂, and R₃ are each the same C₁-C₃ alkyl group, or preferably are each C₂ alkyl group,
R₄ is H or C₁-C₄ alkyl group,
R₅ is a linear C₁-C₃ alkyl group, and
X— is chloro or bromo (Cl⁻ or Br⁻).

In embodiments the alkyl diquaternary compounds have the structure (VI) are a quaternization reaction product of

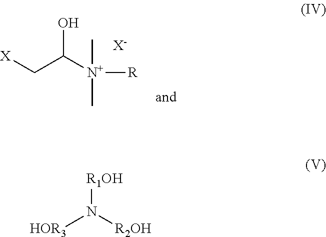

under catalysis of a hydroxide source in a quaternizing reaction as shown schematically in FIG. 1. The quaternization reaction can include a solvent, e.g. propylene glycol and water, at an alkaline pH, e.g. pH 9 or greater, at a suitable temperature range, e.g. 85° C.-90° C. The reagent IV has the structure as shown wherein R is a linear C₈-C₃₀ alkyl group, X is a halogen and X— is a halide. In preferred embodiments R is a linear C₈-C₃₀, C₁₀-C₂₄, or C₁₂-C₂₄ alkyl group. In preferred embodiments R is a lauryl, cocoalkyl, or stearyl group. Preferred halogens include Cl and Br, and preferred halides are the corresponding Cl⁻ and Br⁻. The reagent V has the structure as shown wherein R₁, R₂, and R₃ are independently a linear C₁-C₃ alkyl group, R₁, R₂, and R₃ are the same linear C₁-C₃ alkyl group, or R₁, R₂, and R₃ are each C₂ alkyl group. In embodiments the reaction between IV and V to make the alkyl diquaternary compounds have the structure (VI) have a molar ratio of the two reagents that are about 1:1.

In embodiments the reagent IV is a hydrophobically modified chlorohydrin. In embodiments the hydrophobically modified chlorohydrin has an alkyl R group that is from C₈-C₃₀, such as 3-chloro-2-hydroxypropyl-dimethylstearylammonium chloride, commercially available as Quab 426 sold as a 40% solution in a 1,2-propanediol/water mixture.

In still further embodiments the alkyl diquaternary compounds of structure (VI) has the following structure:

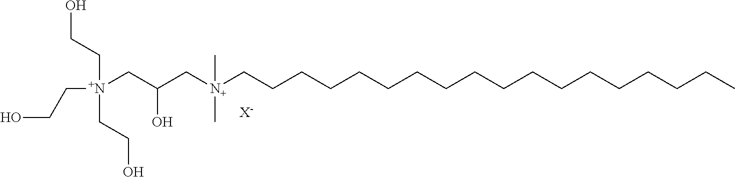

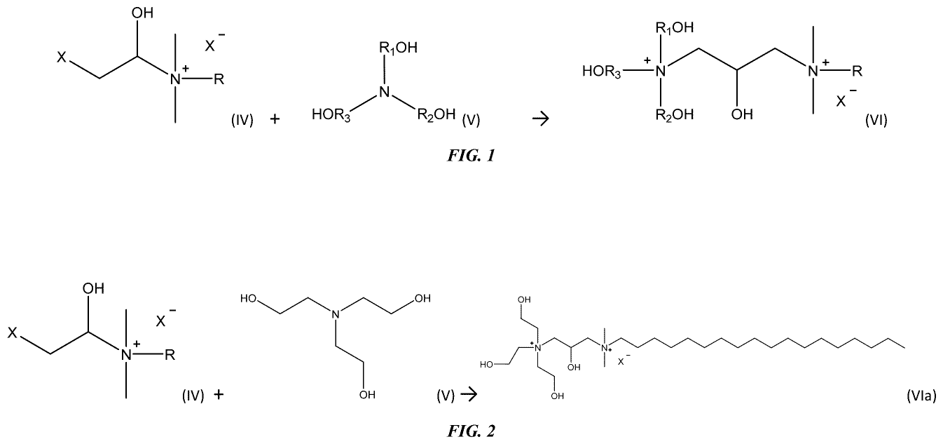

(VIa) wherein X is Cl— or Br— made in a quaternizing reaction as shown schematically in FIG. 2. In embodiments the structure of the alkyl diquaternary compounds of structure (VI) having multiple hydroxyl groups aid in water solubility of the corrosion inhibitor and in water partitioning. Without being limited to a particular mechanism of action, the structure (VI) having multiple hydroxyl groups improve the water partitioning of the compound for use in the corrosion-inhibiting compositions. In addition, the alkyl diquaternary compounds with multiple hydroxyl groups further improve water partitioning of products while also controlling corrosion. The water partitioning is improved with the presence of hydroxyl groups due to increased water solubility that increases the partitioning to the water phase resulting in a greater chemical concentration in the water phase available to interact with the metal surface and, in turn, increases the corrosion inhibition.

In embodiments, the alkyl diquaternary compounds have the following structure (VII):

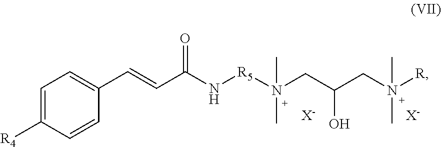

wherein:
R is a linear C₈-C₃₀ alkyl group,
R₁, R₂, and R₃ are independently a linear C₁-C₃ alkyl group,
R₄ is H, —OCH₃, or C₁-C₈ alkyl group,
R₅ is a linear C₁-C₃ alkyl group, and
X— is a halide.

In further embodiments the alkyl diquaternary compounds have the structure (VII):

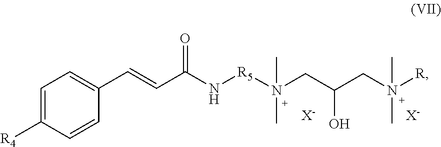

wherein:
R is a linear C₁₀-C₂₄ alkyl group,
R₁, R₂, and R₃ are the same linear C₁-C₃ alkyl group,
R₄ is H, —OCH₃, or C₁-C₄ alkyl group,
R₅ is a linear C₁-C₃ alkyl group, and
X— is a halide, preferably chloro or bromo (Cl⁻ or Br⁻).

In further embodiments the alkyl diquaternary compounds have the structure (VII):

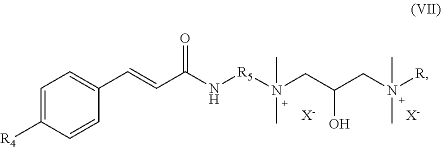

wherein:
R is a linear C₁₂-C₂₄ alkyl group,
R₁, R₂, and R₃ are each C₂ alkyl group,
R₄ is H, or C₁-C₄ alkyl group,
R₅ is a linear C₁-C₃ alkyl group, and
X— is chloro or bromo (Cl⁻ or Br⁻).

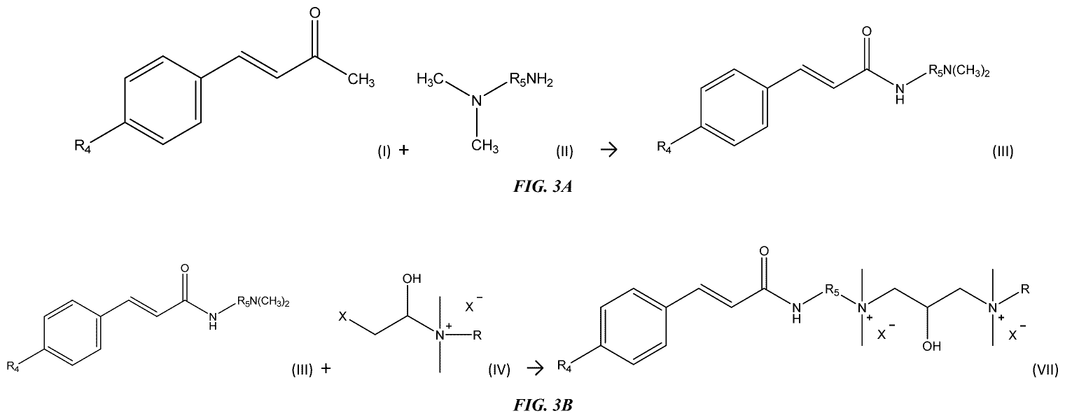

In embodiments the alkyl diquaternary compounds have the structure (VII) are a reaction product of a two-step reaction as shown schematically in FIG. 3A and FIG. 3B. In embodiments the alkyl diquaternary compounds are made from a first step of reacting

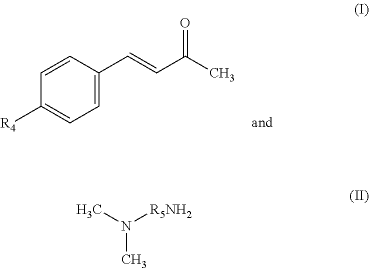

to produce the intermediate (also a reagent for the second step) III as shown schematically in FIG. 3A via an amidation reaction according to conventional reaction conditions (e.g. pH, temperatures (e.g. about 350° F.). The reagent I has the structure as shown wherein R₄ is H, —OCH₃, or C₁-C₈ alkyl group, or preferably R₄ is H or C₁-C₄ alkyl group. The reagent II has the structure as shown wherein R₅ is a linear C₁-C₃ alkyl group.

In embodiments the reaction between I and II to make the intermediate III for the reaction to make the alkyl diquaternary compounds have the structure (VII) have a molar ratio of the two reagents (I and II) that are about 1:1. In embodiments the reaction to product intermediate III does not include a solvent in the reaction.

In embodiments the alkyl diquaternary compounds have the structure (VII) are a reaction product of

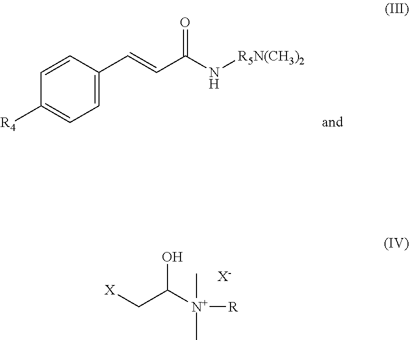

as shown schematically in a quaternizing reaction in FIG. 3B. The quaternization reaction can include a solvent, e.g. propylene glycol and water, at a suitable temperature range, e.g. 85° C.-90° C. Reagent III has the structure as shown wherein R₄ is H, —OCH₃, or C₁-C₈ alkyl group, or preferably R₄ is H, or C₁-C₄ alkyl group, and wherein R₅ is a linear C₁-C₃ alkyl group. The reagent IV has the structure as shown wherein R is a linear C₈-C₃₀ alkyl group, X is a halogen and X— is a halide. In preferred embodiments R is a linear C₈-C₃₀, C₁₀-C₂₄, or C₁₂-C₂₄ alkyl group. In preferred embodiments R is a lauryl, cocoalkyl, or stearyl group. Preferred halogens include Cl and Br, and preferred halides are the corresponding Cl⁻ and Br⁻.

In embodiments the reaction between III and IV to make the alkyl diquaternary compounds have the structure (VII) have a molar ratio of the two reagents that are about 1:1.

In embodiments the reagent IV is a hydrophobically modified chlorohydrin. In embodiments the hydrophobically modified chlorohydrin has an alkyl R group that is from C₈-C₃₀, such as 3-chloro-2-hydroxypropyl-dimethylstearylammonium chloride, commercially available as Quab 426 sold as a 40% solution in a 1,2-propanediol/water mixture.

In further embodiments the alkyl diquaternary compounds of structure (VII) has the following structure:

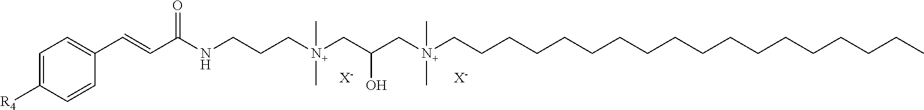

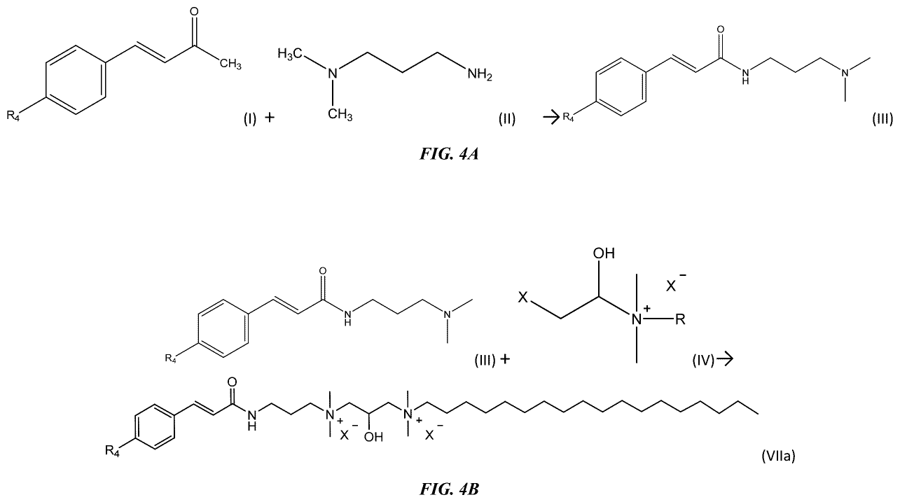

which can made in a two-part quaternizing reaction as shown schematically in FIG. 4A and FIG. 4B.

In embodiments, the alkyl diquaternary compound corrosion inhibitor is included in the corrosion-inhibiting composition at an amount of at least about 10 wt-% to about 70 wt-%, about 10 wt-% to about 60 wt-%, about 20 wt-% to about 60 wt-%, about 20 wt-% to about 50 wt-%, about 25 wt-% to about 50 wt-%, or about 30 wt-% to about 50 wt-%. In addition, without being limited according to the disclosure, all ranges recited are inclusive of the numbers defining the range and include each integer within the defined range.

### Solvent

The alkyl diquaternary compounds are delivered with a solvent in the corrosion-inhibiting composition. In some embodiments at least one solvent is included in the composition. Exemplary solvents include water, organic solvents and/or aromatic solvents.

Exemplary organic solvents can include an alcohol, a hydrocarbon, a ketone, an ether, an alkylene glycol, a glycol ether, an amide, a nitrile, a sulfoxide, an ester, or a combination thereof. Examples of suitable organic solvents include, but are not limited to, methanol, ethanol, propanol, isopropanol (isopropyl alcohol or 2-propanol), butanol, 2-ethylhexanol, hexanol, octanol, decanol, 2-butoxyethanol, glycols and derivatives (ethylene glycol, methylene glycol, 1,2-propylene glycol, 1,3-propylene glycol, diethyleneglycol monomethyl ether, ethylene glycol monobutyl ether, ethylene glycol dibutyl ether, etc.), pentane, hexane, cyclohexane, methylcyclohexane, heptane, decane, dodecane, diesel, toluene, xylene, heavy aromatic naphtha, cyclohexanone, diisobutylketone, diethyl ether, propylene carbonate, N-methylpyrrolidinone, N,N-dimethylformamide, or a combination thereof.

In some embodiments the solvent is one or more of ethylene glycol, propylene glycol, isopropanol, methanol, alkyl alcohol, and/or water.

In some embodiments, an alcohol solvent is used, including straight chain or branched aliphatic such as methanol, ethanol, propanol, isopropanol, butanol, 2-ethylhexanol, hexanol, octanol, decanol, 2-butoxyethanol, etc.

In some embodiments, the composition comprises one or more solvents selected from the group consisting of isopropanol, methanol, ethanol, 2-ethylhexanol, heavy aromatic naphtha, toluene, ethylene glycol, ethylene glycol monobutyl ether (EGMBE), diethylene glycol monoethyl ether, xylene, aromatic solvents, or any combination thereof.

Exemplary aromatic solvents comprise aromatic hydrocarbons such as toluene, xylene, heavy aromatic naphtha, C9-C11 aromatic hydrocarbons (Aromatic 150 or Aromatic Solvent C10) or a combination thereof. Preferably, the aromatic solvent comprises heavy aromatic naphtha or xylene. In any of the embodiments described the aromatic solvent(s) is preferably combined with water.

In some embodiments, the solvent(s) is included in a composition with the chemically modified, maleated unsaturated fatty acid or salt thereof corrosion inhibitors at an amount of at least about 20 wt-% to about 80 wt-%, about 30 wt-% to about 80 wt-%, about 40 wt-% to about 80 wt-%, about 45 wt-% to about 80 wt-%, or about 50 wt-% to about 80 wt-%. In addition, without being limited according to the disclosure, all ranges recited are inclusive of the numbers defining the range and include each integer within the defined range.

### Additional Functional Ingredients

The components of the corrosion-inhibiting composition can further be combined with various functional components suitable for uses disclosed herein. In some embodiments, the corrosion-inhibiting compositions include the alkyl diquaternary compound and at least one solvent make up a large amount, or even substantially all of the total weight of the compositions. In some embodiments, the corrosion-inhibiting compositions include the alkyl diquaternary compound and at least one solvent, further include an additional functional ingredient selected from the group consisting of synergist, additional corrosion inhibitor, surfactants, polymers, pH modifiers, asphaltene inhibitor, paraffin inhibitor, scale inhibitor, chelant, emulsifier, emulsion breaker, water clarifier, dispersant, or combinations thereof make up a large amount, or even substantially all of the total weight of the compositions. For example, in some embodiments few or no additional functional ingredients are disposed therein.

In other embodiments, additional functional ingredients may be included in the corrosion-inhibiting compositions. The functional ingredients provide desired properties and functionalities to the compositions. For the purpose of this application, the term “functional ingredient” includes a material that when dispersed or dissolved in a use and/or concentrate solution, such as an aqueous solution, provides a beneficial property in a particular use. Some particular examples of functional materials are discussed in more detail below, although the particular materials discussed are given by way of example only, and that a broad variety of other functional ingredients may be used. For example, many of the functional materials discussed below relate to materials used in cleaning. However, other embodiments may include functional ingredients for use in other applications.

In some embodiments, the compositions may include synergist, additional corrosion inhibitors, solvents, pH modifiers, surfactants, hydrate inhibitors, scale inhibitors, biocides, salt substitutes, relative permeability modifiers, sulfide scavengers, breakers, asphaltene inhibitors, paraffin inhibitors, metal complexing agents (chelants), emulsifiers, demulsifiers, iron control agents, friction reducers, drag reducing agents, flow improvers, viscosity reducers, and the like. Exemplary types of the various additional functional ingredients is included in U.S. Pat. No. 11,242,480, which is incorporated by reference in its disclosure of the various listings of additional functional ingredients.

In an embodiment the compositions include a non-emulsifier and/or synergist. Non-emulsifiers include but are not limited to polyethers, oxyalkylates, oxyalkylated polymers, oxyalkylated resins, or combinations thereof.

According to embodiments of the disclosure, the combination of any additional functional ingredients may be provided in a composition in the amount from about 0 wt-% and about 50 wt-%, from about 1 wt-% and about 50 wt-%, or from about 1 wt-% and about 20 wt-%. In addition, without being limited according to the disclosure, all ranges recited are inclusive of the numbers defining the range and include each integer within the defined range.

### Sulfur-Containing Species

The corrosion-inhibiting compositions can include a sulfur-containing species, which are often referred to as synergists. An exemplary synergist class includes mercaptan corrosion inhibitors. Mercaptans are a type of organic thiol molecules and can create a stronger passivation layer on the metal surface to increase persistency of the protective film for corrosion inhibition. In most examples, the sulfur based component consists of a primary thio/mercaptan (e.g., 2-mercaptoethanol or mercaptoacetic acid). Mercaptans are a type of organic sulfur compounds, which include mercaptoalkyl alcohol, mercaptoacetic acid, tert-butyl mercaptan, or a combination thereof. A preferred synergist is a mercaptoalkyl alcohol comprising 2-mercaptoethanol.

Additional exemplary synergist class includes amines such as thiol-amines as disclosed in U.S. Pat. No. 11,242,480, which is incorporated herein by reference in its entirety. These thiol-amines include a class of anti-corrosion compounds having the formula:

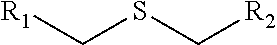

wherein: each R₁ is independently CH₂OH and —C(O)OH; and R₂ is

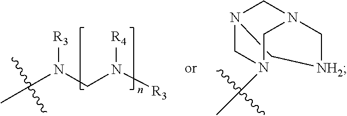

Each R₃ is independently hydrogen or R₅, or both R₃ together form a ring via linker having the formula

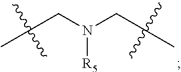

Each R₄ is independently hydrogen or R₅; R₅ is —CH₂SC₂H₅R₁; and n is an integer from 0 to 3.

In some embodiments, the synergist is included in a composition at an amount of at least about 0.1 wt-% to about 20 wt-%, about 1 wt-% to about 20 wt-%, about 5 wt-% to about 20 wt-%, about 5 wt-% to about 15 wt-%, about 1 wt-% to about 10 wt-%, or about 5 wt-% to about 10 wt-%. In addition, without being limited according to the disclosure, all ranges recited are inclusive of the numbers defining the range and include each integer within the defined range.

### Methods of Use

The alkyl diquaternary compounds or the corrosion-inhibiting compositions comprising the alkyl diquaternary compounds are provided to a system in need of effective corrosion control. The methods are suitable for controlling both general and localized corrosion as well as reducing pitting on surfaces.

The alkyl diquaternary compounds or the corrosion-inhibiting compositions can be provided in a single composition to oil-field systems, hydrogen systems, and/or hydrogen mediums or can be combined with other components, such as solvents, synergists, additional corrosion inhibitors and/or other additional functional ingredients, and the like. In referring to compositions, the scope of the methods of use disclosure also includes combining more than one input (i.e. composition) for the treatment of oil-field systems, hydrogen systems, or hydrogen mediums.

The methods of use include adding a corrosive inhibiting effective amount of the corrosion-inhibiting compositions to an oil-field system or hydrogen system or medium having at least one surface and inhibiting corrosion of the at least one surface. Beneficially, the composition reduces corrosion of a surface compared to a corrosive environment that does not contain the alkyl diquaternary compounds. For example, the composition provides improved or at least the same corrosion inhibition of a surface compared to a corrosive environment treated with a conventional quaternary ammonium chloride corrosion inhibitor (e.g. alkyl dimethyl benzyl chloride quat). In embodiments, the corrosion reduction (i.e. inhibition efficiency) is at least about 80%, at least about 90%, at least about 95%, or at least about 99% for a surface comprising metal.

The methods apply the corrosion-inhibiting compositions to a system in need of preventing, reducing or mitigating corrosion. Beneficially, for the corrosion inhibition both localized and generalized corrosion are reduced, as measured by mils penetration per year or milli-inch (one thousandth of an inch) (MPY). MPY is used as an estimated general corrosion rate. The MPY is calculated from the following equation:

$$MPY = ( Δ M [ g ] \cdot C ) / ( ρ [ \frac{g}{{cm}^{2}} ] \cdot A [ {in}^{2} ] \cdot t [ hr ] )$$

where ΔM is the mass loss of the coupon at the end of the test in grams, C is a constant equal to 534000, p is the density of the coupon in g/cm², A is the surface area of the coupon in cm², and t is the exposure time in hours.

The method comprises adding the corrosion-inhibiting compositions in a corrosive inhibiting effective amount. The dosage amounts of the compositions described herein to be added to an oil-field system, hydrogen system or medium can be tailored by one skilled in the art based on factors for each system, including, for example, content of fluid, volume of the fluid, surface area of the system, temperatures, pH, and CO₂ content. In embodiments, an effective amount of the composition is from about 1 ppm to about 5000 ppm, based on the total volume of the system. In embodiments, an effective amount of the composition is from about from about 1 ppm to about 1000 ppm, based on the total volume of the system. In embodiments, an effective amount of the composition is from about from about 10 ppm to about 1000 ppm, based on the total volume of the system. In further embodiments, an effective amount of the composition is from about from about 10 ppm to about 100 ppm, based on the total volume of the system.

The oil-field systems include oil or gas pipelines and refineries, including for example, well, pipeline, fuel storage and/or transportation tanks, fuel distribution system.

The hydrogen systems or hydrogen mediums contain a hydrogen gas, natural gas, hydrogen sulfide gas, ammonia, or a combination thereof. In some embodiments the hydrogen medium comprises hydrogen gas and one or more of methane, ethane, propane, nitrogen, and/or carbon dioxide.

The hydrogen referred to herein may be obtained from many different sources or processes, and may further include combinations, such as mixed streams of hydrogen. For example, “green hydrogen” is hydrogen produced through a water electrolysis process. Carbon dioxide is not emitted during the process. Electricity is used to decompose water into oxygen and hydrogen gas. While “blue hydrogen” may be sourced from fossil fuel, carbon dioxide produced during the process is captured and stored underground, thereby making the overall process carbon neutral. As an additional example, “pink hydrogen” is generated through the electrolysis of water using electricity from a nuclear power plant. Again, the source of the hydrogen to be used in accordance with the present disclosure is not limited so any type of hydrogen or mixed streams with combinations thereof, may be used in accordance with the present disclosure, such as green, blue, pink, gray, black, brown, turquoise, purple, white, red, or where it is generated in the value chain.

Hydrogen systems and mediums can include a wet gas, a dry gas, a dry gas comprising a gas condensate, a wet gas comprising a gas condensate, a wet gas comprising water and a gas condensate, an aqueous medium, a non-aqueous medium, an organic medium, a gaseous medium, and any combination thereof.

In embodiments the hydrogen system or medium can include a hydrogen gas, natural gas, hydrogen sulfide gas, ammonia, or a combination thereof. In some embodiments, the hydrogen medium comprises hydrogen gas and one or more of methane, ethane, propane, nitrogen, and/or carbon dioxide.

The methods are useful in treating surfaces comprising metal in a hydrogen system or medium. In various embodiments the surface is a containment used in the production, transportation (including onshore and offshore hydrogen transportation), storage and/or separation of hydrogen gas.

In various embodiments the surface is a hydrogen system pipeline, oil and gas pipeline and/or refinery surface, including for example, pipelines, storage and/or transportation tanks, distribution systems and the like.

The oil-field system, hydrogen system and/or hydrogen medium include a fluid to which the composition is added. A fluid to which the compositions can be introduced can be a hydrocarbon fluid or gas, produced water, a hydrogen gas, natural gas, hydrogen sulfide gas, ammonia, methane, ethane, propane, nitrogen, carbon dioxide, or combination thereof. As referred to herein, hydrocarbon fluid comprises crude oil, heavy oil, processed residual oil, bituminous oil, coker oils, coker gas oils, fluid catalytic cracker feeds, gas oil, naphtha, fluid catalytic cracking slurry, diesel fuel, fuel oil, jet fuel, gasoline, kerosene, or combinations thereof. In many embodiments, hydrocarbon fluids comprise refined hydrocarbon product. The liquid can also be a heavy brine.

The fluid can be contained in and/or exposed to many different types of apparatuses. In embodiments, the fluid is contained in a containment, such as an oil or gas pipeline. Additionally, the fluid can be contained in refineries, such as surfaces used in the recovery, transportation, refining and/or storage of hydrocarbon fluids or gases.

In embodiments, treated metal containments are provided with the methods described herein. In embodiments a metal containment comprises a metal surface and a barrier or film substantially coating the metal surface with a corrosive inhibiting effective amount of the compositions (or the chemically modified maleated unsaturated fatty acid or salt thereof corrosion inhibitors described herein).

In embodiments, the corrosive inhibiting effective amount of the corrosion-inhibiting compositions comprising the alkyl diquaternary compounds is about 1 ppm to about 5,000 ppm, from about 1 ppm to about 1,000 ppm, or from about 10 ppm to about 1,000 ppm, based on the total volume of the containment. In embodiments, the corrosive inhibiting effective amount of the dialkyl quaternary ammonium compound in the corrosion-inhibiting compositions is about 1 ppm to about 5,000 ppm, from about 1 ppm to about 1,000 ppm, or from about 10 ppm to about 1,000 ppm, based on the total volume of the containment.

The oil-field systems, hydrogen system and/or hydrogen medium comprise a surface in need of corrosion inhibition. Exemplary surfaces in an oil-field system can include separation vessels, dehydration units, gas lines, oil and/or gas pipelines, or other part of an oil and/or gas refinery. Similarly, the fluid can be contained in and/or exposed to an apparatus used in oil extraction and/or production, such as a wellhead. The apparatus can be part of a coal-fired power plant. The apparatus can be a scrubber (e.g., a wet flue gas desulfurizer, a spray dry absorber, a dry sorbent injector, a spray tower, a contact or bubble tower, or the like). The apparatus can be a cargo vessel, a storage vessel, a holding tank, or a pipeline connecting the tanks, vessels, or processing units. Further exemplary surfaces in a hydrogen system or medium can include a containment used in the production, transportation (including onshore and offshore hydrogen transportation), storage and/or separation of hydrogen gas, including for example pipelines, storage and/or transportation tanks, distribution systems and the like.

The system comprises a metal surface subject to corrosion. In embodiments the surfaces can include a variety of metal surfaces that are subject to corrosion. The metals can comprise a component selected from the group consisting of mild steel, galvanized steel, carbon steel, aluminum, aluminum alloys, copper, copper nickel alloys, copper zinc alloys, brass, chrome steels, ferritic alloy steels, austenitic stainless steels, precipitation-hardened stainless steels, high nickel content steels, and any combination thereof.

The compositions are particularly well suited for corrosion inhibition in harsh conditions, including temperatures, flow line conditions (e.g. low and high shear stress, e.g. >50 Pa), high water cut (e.g. >20%), and the like.

The compositions are applied to fluids in an oil-field system, hydrogen system and/or hydrogen medium at varying pH ranges. In an embodiment the pH of the fluids will be between about 2 and about 8.

The compositions can be applied to a fluid in an oil-field system, hydrogen system and/or hydrogen medium at any selected temperature, such as ambient temperature or an elevated temperature. The fluid (e.g., liquid hydrocarbon) can be at a temperature of from about −250° C. to about 300° C., or from about −250° C. to about 250° C., or most often between about −20° C. to about 50° C.

The compositions can be applied by any appropriate method for ensuring dispersal through the fluid. The compositions can be applied to a fluid using various well-known methods and they can be applied at numerous different locations throughout a given system. For example, the compositions can be injected using mechanical equipment such as chemical injection pumps, piping tees, injection fittings, atomizers, quills, and the like. For example, the compositions can be pumped into a system, such as an oil and/or gas pipeline, using an umbilical line. A capillary injection system can be used to deliver the compositions to a selected fluid.

The compositions can be added to the system by any suitable means, including for example by injecting the composition into a fluid or gas in contact with the metal surface, pumping the composition onto the metal surface, pouring the composition onto the metal surface, spraying the composition onto the metal surface, wiping the metal surface with the composition, coating the metal surface with the composition, dipping the metal surface in the composition, soaking the metal surface in the composition, or any combination thereof.

The compositions can be added to the system manually or automatically in either a batch or continuous manner to provide the effective amount of the corrosion-inhibiting composition. In some embodiments, the compositions (or in further embodiments the dialkyl quaternary ammonium compound in the corrosion-inhibiting compositions) are added to a flow line to provide a corrosive inhibiting effective amount from about 1 to about 5,000 parts per million (ppm), about 1 ppm to about 1,000 ppm, or about 10 ppm to about 1,000 ppm, based on the total volume of the system. In some embodiments, the compositions are added to a flow line to provide a corrosive inhibiting effective amount from at least about 1 ppm, 2 ppm, 5 ppm, 10 ppm, 20 ppm, 50 ppm, 100 ppm, 200 ppm, 250 ppm, 500 ppm, or 1,000 ppm based on the total volume of the system. Each system can have its own dose level requirements, and the effective dose level of the composition to sufficiently reduce the rate of corrosion can vary with the system in which it is used.

The compositions can be added to the system by any suitable means, including for example by injecting the composition into a fluid or gas in contact with the metal surface, pumping the composition onto the metal surface, pouring the composition onto the metal surface, spraying the composition onto the metal surface, wiping the metal surface with the composition, coating the metal surface with the composition, dipping the metal surface in the composition, soaking the metal surface in the composition, or any combination thereof.

### EMBODIMENTS

The present disclosure is further defined by the following numbered embodiments:

1. A corrosion-inhibiting composition comprising: an alkyl diquaternary compound having at least one of the following structures:

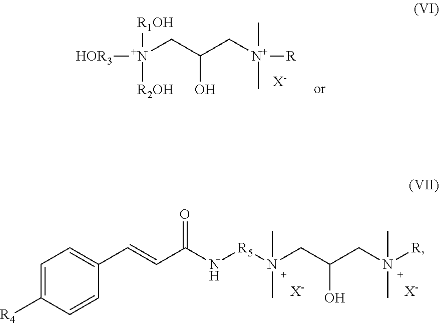

wherein: R is a linear C₈-C₃₀ alkyl group, R₁, R₂, and R₃ are independently a linear C₁-C₃ alkyl group, R₄ is H, —OCH₃, or C₁-C₈ alkyl group, R₅ is a linear C₁-C₃ alkyl group, and X— is a halide, and a solvent.

2. The composition of embodiment 1, wherein the diquaternary compound (VI) is a reaction product of

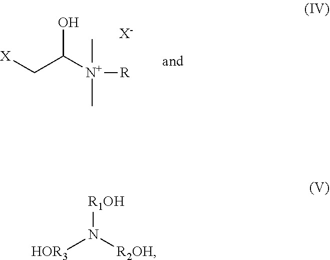

wherein R is a linear C₈-C₃₀ alkyl group and X— is a halide, and R₁, R₂, and R₃ are independently a linear C₁-C₃ alkyl group, under catalysis of a hydroxide source.

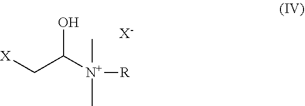

3. The composition of embodiment 2, wherein the (IV) reagent is a hydrophobic modified chlorohydrin.

4. The composition of any one of embodiments 1-3, wherein the diquaternary compound (VI) has the following structure:

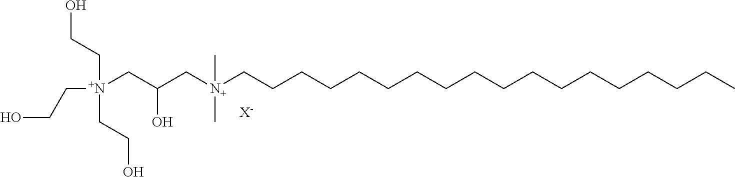

(VIa) wherein X is Cl— or Br—.

5. The composition of embodiment 1, wherein the diquaternary compound (VII) is a reaction product of

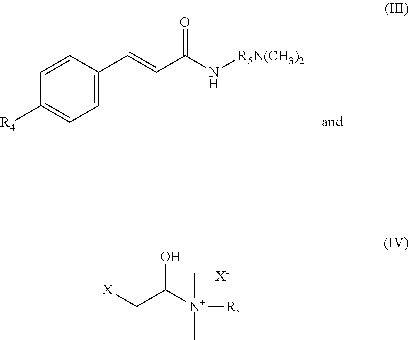

wherein R₄ is H, —OCH₃, or C₁-C₈ alkyl group, R₅ is a linear C₁-C₃ alkyl group, R is a linear C₈-C₃₀ alkyl group and X— is a halide.

6. The composition of embodiment 5, wherein the

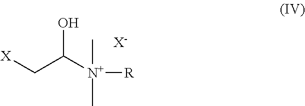

reagent is a hydrophobic modified chlorohydrin.

7. The composition of any one of embodiments 5-6, wherein structure III is the reaction product of

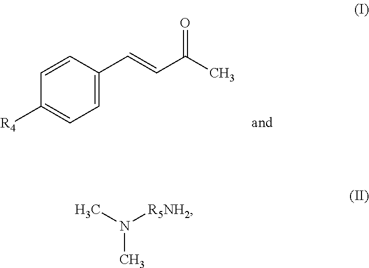

wherein R₄ is H, —OCH₃, or C₁-C₈ alkyl group, R₅ is a linear C₁-C₃ alkyl group.

8. The composition of any one of embodiments 5-7, wherein the diquaternary compound (VII) has the following structure:

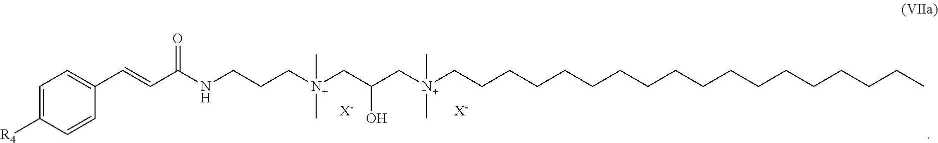

9. The composition of any one of embodiments 1-8, wherein the solvent comprises water, an organic solvent, aromatic solvent, or combination thereof.

10. The composition of any one of embodiments 1-9, further comprising at least one additional component selected from the group consisting of sulfur-containing agent, additional corrosion inhibitors, surfactants, polymers, pH modifiers, asphaltene inhibitors, paraffin inhibitors, scale inhibitors, metal complexing agents (chelants), emulsifiers, water clarifiers, dispersants, emulsion breakers, or combinations thereof.

11. The composition of any one of embodiments 1-10, wherein the alkyl diquaternary compound comprises from about 10 wt-% to about 70 wt-% of the composition and the solvent comprises from about 20 wt-% to about 80 wt-% of the composition.

12. The composition of embodiment 11, further comprising a sulfur-containing agent in an amount from about 1 wt-% to about 10 wt-% of the composition.

13. A method of controlling corrosion on a surface comprising: providing a corrosive inhibiting effective amount of a corrosion inhibition composition according to any one of embodiments 1-12 into contact with a surface comprising metal in an oil-field system, a hydrogen system and/or a hydrogen medium and wherein the contacting is added in a batch or continuous application, and reducing corrosion on the surface.

14. The method of embodiment 13, wherein the corrosive inhibiting effective amount of the composition is from about 10 ppm to about 1,000 ppm based on the total volume of the system.

15. The method of any one of embodiments 13-14, wherein the metal surface comprises steel.

16. The method of embodiment 15, wherein the surface is a containment used in the production, transportation, storage and/or separation of crude oil, natural gas or a biofuel process.

17. The method of any one of embodiments 13-16, wherein the system comprises a hydrocarbon fluid or gas, produced water, or combination thereof.

18. A treated metal containment comprising: a metal containment comprising a metal surface; and a barrier or film substantially coating the metal surface with a corrosive inhibiting effective amount of the composition according to any one of embodiments 1-12.

19. The treated metal containment of embodiment 18, wherein the corrosive inhibiting effective amount of the corrosion inhibitor is from about 10 ppm to about 1,000 ppm, based on the total volume of the containment.

20. The treated metal containment of any one of embodiments 18-19, wherein the metal surface comprises steel.

21. The treated metal containment of any one of embodiments 18-20, wherein the metal surface is a metal containment used in the production, transportation, storage and/or separation of crude oil, natural gas or a biofuel process.

### EXAMPLES

Embodiments of the present disclosure are further defined in the following non-limiting Examples. It should be understood that these Examples, while indicating certain embodiments of the disclosure, are given by way of illustration only. From the above discussion and these Examples, one skilled in the art can ascertain the essential characteristics of this disclosure, and without departing from the spirit and scope thereof, can make various changes and modifications of the embodiments of the disclosure to adapt it to various usages and conditions. Thus, various modifications of the embodiments of the disclosure, in addition to those shown and described herein, will be apparent to those skilled in the art from the foregoing description. Such modifications are also intended to fall within the scope of the appended claims.

### Example 1

### Preparation of the Alkyl Diquaternary Compounds for Corrosion Inhibition

A first alkyl diquaternary compound of structure VIa was prepared as a reaction product of Quab 426 and triethanolamine under the catalysis of caustic. In a 250-ml 4 neck round flask equipped with overhead stirrer, thermal controller, and condenser, 127.8 gram of Quab 426, 18.216 gram of triethanolamine and drops of caustic were loaded while stirring. It was heated it up to 85-90° C. and stopped when conversion rate was 90%.

A second alkyl diquaternary compound of structure VIIa was prepared as a reaction product of a two-step synthesis. First, in a 1000-ml 5 neck round flask equipped with overhead stirrer, thermal control, condenser, and charged with 331.25 grams of methyl trans-cinnamate and 208 grams of DMAPA. It was heated up to 135° C. and stopped when the tertiary amine value was 95% of total amine value of the product. Then in a 250-ml 4 neck round flask equipped with overhead stirrer, thermal controller, and condenser, 24.27 grams of the first reaction product and 106.46 grams of Quab 426 were charged while stirring. It was heated to 85° C. and stopped cooking when the conversion rate was more than 95% by titration of Chloride content.

### Example 2

Examples were conducted to assess the corrosion inhibitors produced in Example 1 using bubble cell tests to assess corrosion performance using linear polarization resistance testing. The corrosion inhibitor was combined with the sulfur synergist 2-mercaptoethanol.

The bubble test simulates low flow areas where little or no mixing of water and oil occurs. The test was conducted using synthetic brine (80% of the brine and 20% of a hydrocarbon containing LVT-200) as shown in Table 1.

TABLE 1

| Salt | Mass (g/L) |
|---|---|
| NaCl | 12.7518 |
| CH₃COONa | 3.3206 |
| Na₂SO₄ | 0.0503 |
| NaHCO₃ | 0.7242 |
| KCl | 0.1563 |
| CaCl₂•H₂O | 0.6749 |

The brine was placed into kettles and purged with carbon dioxide resulting in carbon dioxide saturated brine. The brine was continually purged with carbon dioxide at 1 bar CO₂ to saturate the brine prior to starting the test for a 2 hour pre-corrode. After the test began, the test cell was blanketed with carbon dioxide one hour prior to electrode insertion and through the duration of the test to maintain saturation. The kettles were stirred at 100 revolutions per minute (rpm) for the duration of the test at 66° C.

The corrosion rate was measured by Linear Polarization Resistance (LPR) techniques. The working electrode used was carbon steel (C₁₀₁₈ grade). The counter and reference electrodes were both 1018 carbon steel. The electrodes were all cleaned and polished prior to testing. Data were collected for 2 hours before 10 ppm of the corrosion inhibitor composition (containing 20% of the reaction product corrosion inhibitor) was added to the hydrocarbon phase, equating to 2 ppm of the active reaction product corrosion inhibitor with 0.5 ppm 2-mercaptoethanol being introduced into the test cell. Data were collected overnight for 22 hour test duration. The results are summarized in Table 2.

TABLE 2

| | | | 2-mer- | | Corrosion | |
|---|---|---|---|---|---|---|
| | | | capto- | Avg. | rate after | |
| CI | 2-mer- | | ethanol | Blank | 22 hour | |
| Dosage | capto- | CI | active | Corrosion | CI | % |
| (active/ | ethanol | Dosage | injected | Rate | injection | Protec- |
| ppm) | (%) | (ppm) | (ppm) | (mpy) | (mpy) | tion |
| CI Active | 5 | 10 | 0.5 | 226.1 | 1.5 | 99.3 |
| (VIa) 20% | | | | | | |
| active 2 | | | | | | |
| ppm | | | | | | |
| CI Active | 5 | 10 | 0.5 | 225.1 | 1.7 | 99.2 |
| (VIIa) 20% | | | | | | |
| active 2 | | | | | | |
| ppm | | | | | | |
| 20% alkyl | 5 | 10 | 0.5 | 208.5 | 1.4 | 99.3 |
| dimethyl | | | | | | |
| benzyl | | | | | | |
| chloride | | | | | | |
| quat | | | | | | |
| (Positive | | | | | | |
| Control) | | | | | | |

The results show the use of dialkyl quaternary compounds of structures VI and VII provide at least the same corrosion inhibition as conventional quaternary ammonium compounds. Beneficially the structure of the dialkyl quaternary compounds and use of the corrosion-inhibiting compositions comprising the dialkyl quaternary compounds allow for use and effective corrosion inhibition under harsh conditions such as higher shear stress, high temperature and high water cuts as further demonstrated in the subsequent Example.

### Example 3

Further corrosion inhibition efficacy was evaluated with a Corrosion Buchi autoclave test performed with the following conditions to evaluate corrosion performance of the corrosion inhibitor produced in Example 1 on carbon steel coupons (X65 grade). The corrosion rate was calculated based on weight loss and the pit depth was obtained using Bruker Npflex Profilometer.

The test conditions included: 121° C., 100% pre-partitioned synthetic brine as described in Table 1, 16 psi CO₂, 100 psi N₂, 130 Pa shear stress, for 7 days. After the tests, X— 65 flat were cleaned for mass loss to calculate general corrosion rate and also scanned using the Bruker Npflex Profilometer to measure pit depth.

The pre-partition conditions included: 60° C., 40% synthetic brine as described in Table 1 and 60% hydrocarbon, 150 ppm of the evaluated corrosion inhibitor from Example 2 (combination of both VIa and VIIa corrosion inhibitors blended with 0.5 ppm 2-mercaptoethanol), mixed at 500 rpm for 30 minutes, allowing separation prior to transferring brine to the autoclave.

Results of the Buchi autoclave testing are shown in Table 3.

TABLE 3

| | CI | | Corrosion Rate | Average pit depth |
|---|---|---|---|---|
| CI chemistry | activity | Dosage | after 7-day test | after 7-day test |
| tested | (%) | (ppm) | (mpy) | (μm) |
| Blank | N/A | N/A | 4.39 | 44 |
| Example 2 CI | 23 | 150 | 1.87 | 14.8 |
| (VIa and VIIa) | | | | |

The results show the evaluated corrosion inhibitors provide corrosion inhibition efficacy. The compound reduced mpy as well as pit depth. The Buchi testing further confirms efficacy of the corrosion inhibitors to further supplement the comparative testing of the bubble cell tests.

### Example 4

Additional comparison testing was conducted on the alkyl diquaternary compound corrosion inhibitor of Example 1 (corrosion inhibitor VIa) compared to as conventional quaternary ammonium compounds. Partitioning tests were conducted of the corrosion inhibitor (VIa) and a quaternary ammonium compound (trimethylstearyl benzyl chloride quat) to determine the partitioning coefficient via LC-MS (Liquid Chromatography-Mass Spectroscopy) analysis.

At room temperature, 50 mL of the synthetic brine of Table 1, 25 mL of aromatic 150, and 25 mL of LVT 200 were pipetted into a 125-mL separational funnel. 50 ppm of the corrosion inhibitor (VIa) or trimethylstearyl benzyl chloride quat were dosed into the oil layer of the funnel. The cap was inserted into the funnel and the mixture was shaken vigorously for one minute and then set for an hour. After the hour rest, the bottom layer (brine layer) was drained and collected for LC-MS analysis. LC-MS analysis determines the amount of the corrosion inhibitor (VIa) and trimethylstearyl benzyl chloride quat that partitioned into the brine phase. The amount found in the brine phase was compared to the original amount introduced into the oil phase of the brine/oil solution (50 ppm) and a percentage amount is calculated. The percent amount of the corrosion inhibitor (VIa) and trimethylstearyl benzyl chloride quat present in the brine phase is shown in Table 4.

TABLE 4

| | % Partitioning to |
|---|---|
| Tested Formulations | brine phase |
| Corrosion Inhibitor (VIa) | 84.1 |
| Trimethylstearyl benzyl | 28.4 |
| chloride quat | |

As shown in Table 4, the alkyl diquaternary compounds of structure VI more effectively partitions to the brine phase over oil phase with over 80% of the total corrosion inhibitor included into the brine/oil solution. Comparatively, only 28.4% of the trimethylstearyl benzyl chloride quat is partitioned to the brine phase. Thus, the alkyl diquaternary corrosion inhibitor demonstrated a significant improvement in water partitioning over conventional quaternary ammonium compounds. Without being limited according to a particular mechanism of action, the additional quaternized nitrogen and the hydroxyl groups in structure VI enhance the water solubility largely due to the hydroxyl groups forming multiple hydrogen bonds with water and contributing to water solubility and the quaternized nitrogen enhancing water solubility through ion-dipole interactions.

These results confirm the dialkyl quaternary compound corrosion inhibitor provides an improved partitioning which is important for the corrosion inhibitor to be present in the water phase and reach the metal surface in need of corrosion inhibitor. In embodiments the corrosion inhibitors described herein provide improved partitioning between the oil, water and solid phases of fluid within a system or containment.

It is to be understood that while the invention has been described in conjunction with the detailed description thereof, the foregoing description is intended to illustrate, and not limit the scope of the invention, which is defined by the scope of the appended claims. Other embodiments, advantages, and modifications are within the scope of the following claims. Any reference to accompanying drawings which form a part hereof, are shown, by way of illustration only. It is understood that other embodiments may be utilized and structural changes may be made without departing from the scope of the present disclosure. All publications discussed and/or referenced herein are incorporated herein in their entirety.

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be utilized for realizing the invention in diverse forms thereof.

What is claimed is:

1. A corrosion-inhibiting composition comprising:
an alkyl diquaternary compound having at least one of the following structures: 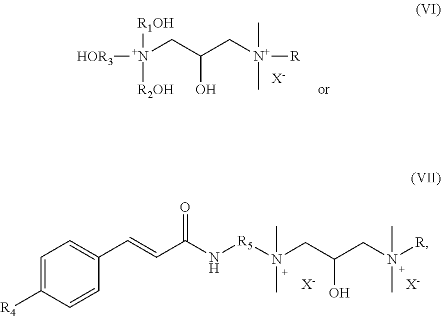
wherein:
R is a linear C₈-C₃₀ alkyl group,
R₁, R₂, and R₃ are independently a linear C₁-C₃ alkyl group,
R₄ is H, —OCH₃, or C₁-C₈ alkyl group,
R₅ is a linear C₁-C₃ alkyl group, and
X— is a halide, and
a solvent.

2. The composition of claim 1, wherein the diquaternary compound (VI) is a reaction product of 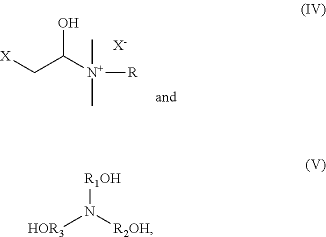
wherein R is a linear C₈-C₃₀ alkyl group and X— is a halide, and R₁, R₂, and R₃ are independently a linear C₁-C₃ alkyl group, under catalysis of a hydroxide source.

3. The composition of claim 2, wherein the 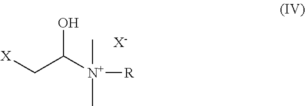
reagent is a hydrophobic modified chlorohydrin.

4. The composition of claim 2, wherein the diquaternary compound (VI) has the following structure: 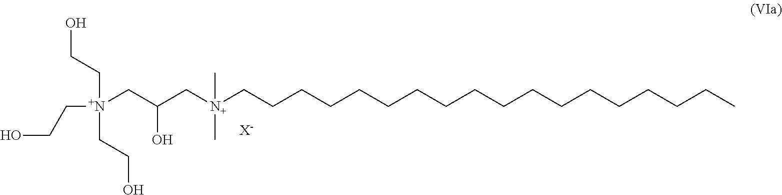
wherein X is Cl— or Br—.

5. The composition of claim 1, wherein the diquaternary compound (VII) is a reaction product of 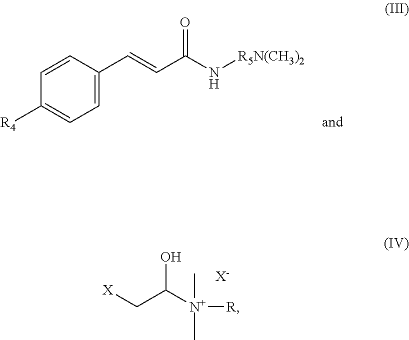
wherein R₄ is H, —OCH₃, or C₁-C₈ alkyl group, R₅ is a linear C₁-C₃ alkyl group, R is a linear C₈-C₃₀ alkyl group and X— is a halide.

6. The composition of claim 5, wherein the 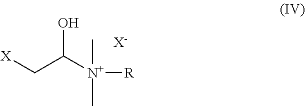
reagent is a hydrophobic modified chlorohydrin.

7. The composition of claim 5, wherein structure III is the reaction product of 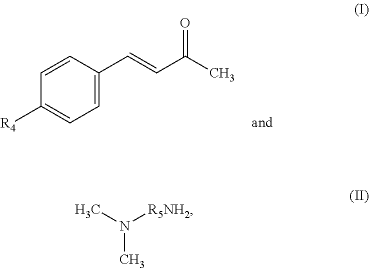
wherein R₄ is H, —OCH₃, or C₁-C₈ alkyl group, R₅ is a linear C₁-C₃ alkyl group.

8. The composition of claim 5, wherein the diquaternary compound (VII) has the following structure:

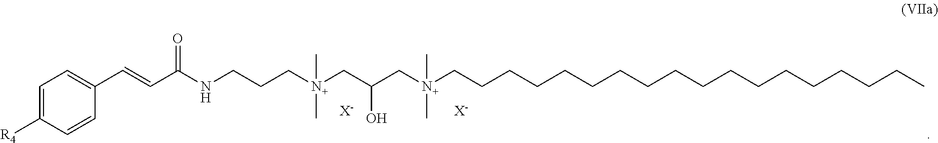

9. The composition of claim 1, wherein the solvent comprises water, an organic solvent, aromatic solvent, or combination thereof.

10. The composition of claim 1, further comprising at least one additional component selected from the group consisting of sulfur-containing agent, additional corrosion inhibitors, surfactants, polymers, pH modifiers, asphaltene inhibitors, paraffin inhibitors, scale inhibitors, metal complexing agents, emulsifiers, water clarifiers, dispersants, emulsion breakers, or combinations thereof.

11. The composition of claim 1, wherein the alkyl diquaternary compound comprises from about 10 wt-% to about 70 wt-% of the composition and the solvent comprises from about 20 wt-% to about 80 wt-% of the composition.

12. The composition of claim 11, further comprising a sulfur-containing agent in an amount from about 1 wt-% to about 10 wt-% of the composition.

13. A method of controlling corrosion on a surface comprising:
providing a corrosive inhibiting effective amount of a corrosion inhibition composition according to claim 1 into contact with a surface comprising metal in an oil-field system, a hydrogen system and/or a hydrogen medium, and
wherein the contacting is added in a batch or continuous application, and reducing corrosion on the surface.

14. The method of claim 13, wherein the corrosive inhibiting effective amount of the composition is from about 10 ppm to about 1,000 ppm based on the total volume of the system.

15. The method of claim 13, wherein the metal surface comprises steel.

16. The method of claim 15, wherein the surface is a containment used in the production, transportation, storage and/or separation of crude oil, natural gas or a biofuel process.

17. The method of claim 13, wherein the system comprises a hydrocarbon fluid or gas, produced water, or combination thereof.

18. A treated metal containment comprising:
a metal containment comprising a metal surface; and
a barrier or film substantially coating the metal surface with a corrosive inhibiting effective amount of the composition according to claim 1.

19. The treated metal containment of claim 18, wherein the corrosive inhibiting effective amount of the corrosion inhibitor is from about 10 ppm to about 1,000 ppm, based on the total volume of the containment.

20. The treated metal containment of claim 18, wherein the metal surface comprises steel.

21. The treated metal containment of claim 18, wherein the metal surface is a metal containment used in the production, transportation, storage and/or separation of crude oil, natural gas or a biofuel process.
